(19) United States
(12) Patent Application Publication
(10) Pub. No.: US 2020/0110817 A1
(43) Pub. Date: Apr. 9, 2020

(54) METHOD, APPARATUS, AND SYSTEM FOR PROVIDING QUALITY ASSURANCE FOR MAP FEATURE LOCALIZATION

(71) Applicant: HERE GLOBAL B.V., Eindhoven (NL)

(72) Inventor: Anirudh VISWANATHAN, Berkeley, CA (US)

(21) Appl. No.: 16/152,134

(22) Filed: Oct. 4, 2018

(51) Int. Cl. G06F 17/30

(52) U.S. Cl. CPC G06F 17/30241; G06F 17/30303; G06F 17/30598

(57) ABSTRACT

An approach is provided for quality assurance of map feature localization. The approach involves, for example, processing sensor data collected from a plurality of vehicles to aggregate a plurality of features indicated in the sensor data into a feature set. The approach also involves clustering the feature set into a plurality of feature clusters. The approach further involves determining a consensus pattern based on the plurality of feature clusters. The approach further involves determining at least one feature cluster of the plurality of feature clusters that does not match the consensus pattern. The approach further involves automatically designating the sensor data corresponding to the at least one feature cluster as inaccurate sensor data.

### BACKGROUND

Advances in computer vision systems and feature detectors (e.g., machine learning based feature detectors such as neural networks) are leading to accelerated development of autonomous driving and related mapping/navigation services (e.g., high definition (HD) digital maps). For example, these systems and feature detectors can be used for creating and updating digital map data by more quickly detecting and locating map features to include in digital maps. Despite these advances, however, service providers and map developers continue to face significant technical challenges to ensuring the that the data for creating or updating maps are high quality (e.g., accurate, up-to-date, etc.) especially when capturing data in a crowd-sourced manner.

### SOME EXAMPLE EMBODIMENTS

Therefore, there is a need for an approach for providing quality assurance of map feature localization, e.g., for digital map updates and/or creation.

According to one embodiment, a computer-implemented method comprises processing sensor data collected from a plurality of vehicles to aggregate a plurality of features indicated in the sensor data into a feature set. The method also comprises clustering the feature set into a plurality of feature clusters. The method further comprises determining a consensus pattern based on the plurality of feature clusters. The method further comprises determining at least one feature cluster of the plurality of feature clusters that does not match the consensus pattern. The method further comprises automatically designating the sensor data corresponding to the at least one feature cluster as inaccurate sensor data.

According to another embodiment, an apparatus comprises at least one processor, and at least one memory including computer program code for one or more computer programs, the at least one memory and the computer program code configured to, with the at least one processor, cause, at least in part, the apparatus to process sensor data collected from a plurality of vehicles to aggregate a plurality of features indicated in the sensor data into a feature set. The apparatus is also caused to cluster the feature set into a plurality of feature clusters. The apparatus is further caused to determine a consensus pattern based on the plurality of feature clusters. The apparatus is further caused to determine at least one feature cluster of the plurality of feature clusters that does not match the consensus pattern. The apparatus is further caused to automatically designate the sensor data corresponding to the at least one feature cluster as inaccurate sensor data.

According to another embodiment, a non-transitory computer-readable storage medium carries one or more sequences of one or more instructions which, when executed by one or more processors, cause, at least in part, an apparatus to process sensor data collected from a plurality of vehicles to aggregate a plurality of features indicated in the sensor data into a feature set. The apparatus is also caused to cluster the feature set into a plurality of feature clusters. The apparatus is further caused to determine a consensus pattern based on the plurality of feature clusters. The apparatus is further caused to determine at least one feature cluster of the plurality of feature clusters that does not match the consensus pattern. The apparatus is further caused to automatically designate the sensor data corresponding to the at least one feature cluster as inaccurate sensor data.

According to another embodiment, an apparatus comprises means for processing sensor data collected from a plurality of vehicles to aggregate a plurality of features indicated in the sensor data into a feature set. The apparatus also comprises means for clustering the feature set into a plurality of feature clusters. The apparatus further comprises means for determining a consensus pattern based on the plurality of feature clusters. The apparatus further comprises means for determining at least one feature cluster of the plurality of feature clusters that does not match the consensus pattern. The apparatus further comprises means for automatically designating the sensor data corresponding to the at least one feature cluster as inaccurate sensor data.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing quality assurance for map feature localization, according to one embodiment;

FIG. 2 is diagram illustrating an example of localizing crowd-sourced road feature observations, according to one embodiment;

FIG. 3 is a diagram illustrating an example of reporting road feature observations from a vehicle, according to one embodiment;

FIG. 4 is a diagram of the components of a mapping platform capable of providing quality assurance for map feature localization, according to one embodiment;

FIG. 5 is a flowchart of a process for providing quality assurance for map feature localization, according to one embodiment;

FIG. 6 is a diagram illustrating an example of providing quality assurance for map feature localization, according to one embodiment;

FIG. 7 is a diagram illustrating an example of using quality assurance filtered feature data for autonomous driving, according to one embodiment;

FIG. 8 is a diagram of a geographic database, according to one embodiment;

FIG. 9 is a diagram of hardware that can be used to implement an embodiment;

FIG. 10 is a diagram of a chip set that can be used to implement an embodiment; and

FIG. 11 is a diagram of a mobile terminal (e.g., handset or other mobile device, like a vehicle or part thereof) that can be used to implement an embodiment.

### DESCRIPTION OF SOME EMBODIMENTS

Examples of a method, apparatus, and computer program for providing quality assurance of map feature localization are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

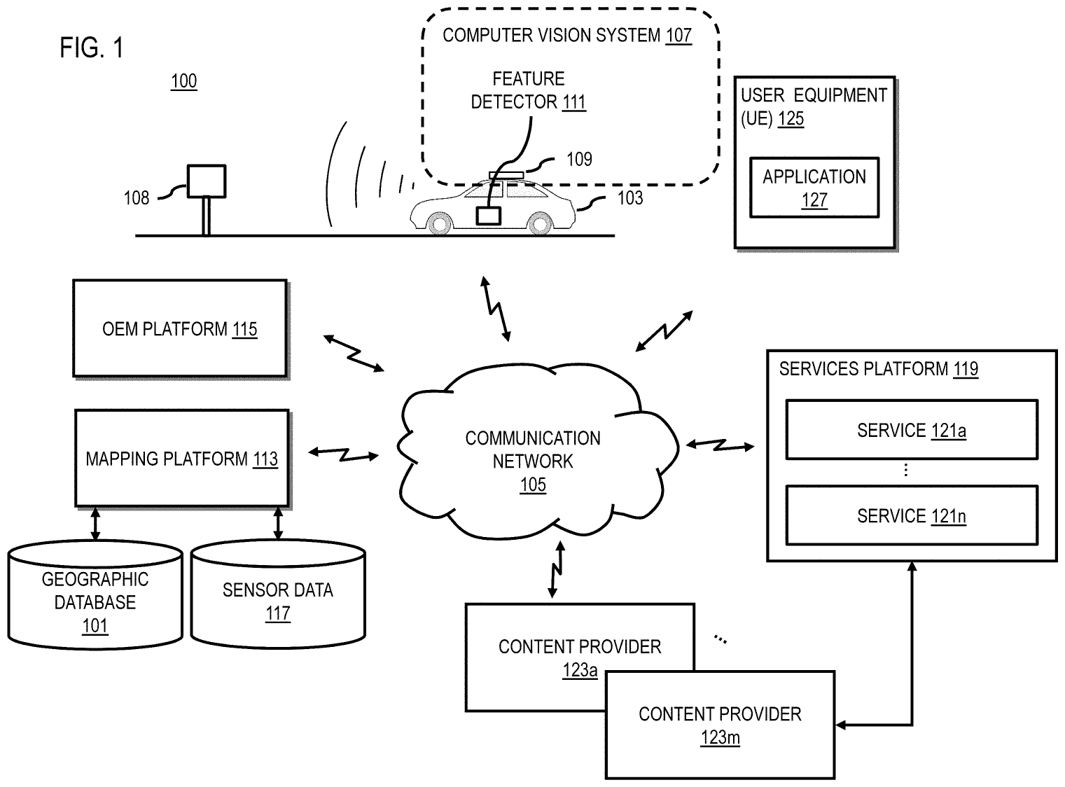

FIG. 1 is a diagram of a system capable of providing quality assurance for map feature localization, according to one embodiment. A digital map (e.g., such as that provided by a geographic database 101) can play a crucial role in enabling automated driving use-cases. When used for such use-cases, service providers generally target a goal providing high definition (HD) maps (e.g., maps achieving centimeter-level accuracy or better) that approach 100% or near 100% accuracy relative to some known/pre-determined locations (i.e., ground truth location data). Achieving such goals can require almost continuous and extensive map updates to ensure that any changes to the mapped areas or mapped road networks are reflected in the digital map data of the geographic database 101 as quickly as possible. These map updates, in turn, can require considerable resources to support fleets of dedicated mapping vehicles to travel the map updates and record any map feature changes.

In one embodiment, an approach to reducing this resource burden is to crowd-source raw sensor data from consumer or user vehicles (e.g., a vehicle 103) that are already operating in a road network. Modern consumer vehicles are getting “smarter”, better equipped, and more connected (e.g., connected to a communication network 105), and are suited for providing crowd-sourced sensor data for generating map updates. As shown in FIG. 1, the vehicle 103 can be equipped with a computer vision system 107 that includes advanced sensors 109 (e.g., cameras, LiDAR sensors, infrared sensors, location sensors, etc.) coupled with a feature detector 111 (e.g., machine learning-based feature detectors or models) to detect a map feature 108 (e.g., a road sign, road furniture, terrain feature, etc.) based on sensor data collected from the sensors 109.

Since there can be potentially thousands of crowd-sourced cars or vehicles 103 traveling in road network and reporting sensor data, the system 100 can provide, in some embodiments, updated digital map data (e.g., including data learned about any map feature, road furniture, etc.) in near real time. Thus, when using data from crowd-sourced vehicle-based sensors 109, the system 100 can update the digital map data of the geographic database 101 at higher frequencies (e.g., every few hours) than traditional processes.

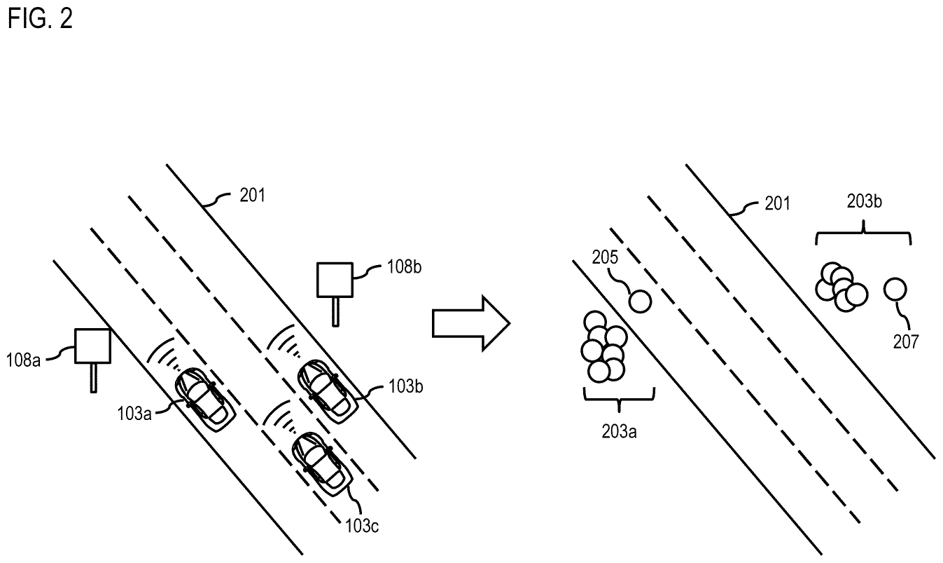

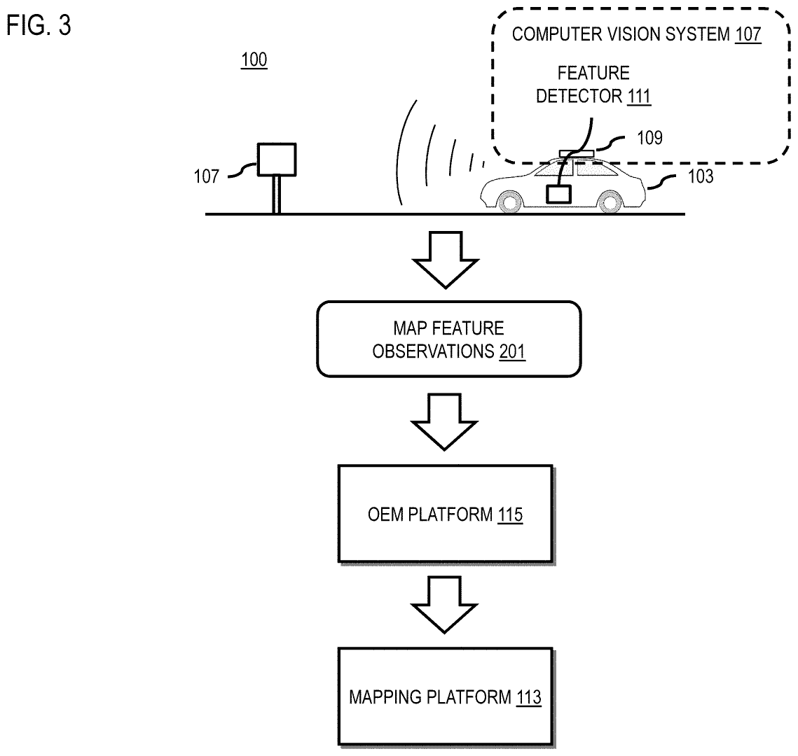

However, the challenge with crowd-sourced data collection efforts for map update is that data accuracy can be unreliable. For example, crowd-sourced sensor data collected from regions of GPS-dropout or other cases of inaccurate sensor readings can lead to misplaced map-features in the map update step. In other words, location data reported or extracted from collected raw sensor data (e.g., feature observation reports) can be inaccurate (e.g., satellite-based positioning systems such as GPS can be inaccurate in dense urban areas with high buildings), thereby resulting in the system 100 map-matching or localizing the feature observation report to an inaccurate map location. A typical approach to registering multiple data sources (e.g., multiple feature observation reports from multiple drives of the vehicles 103) to a map location, is to use a localization technique, which fuses sensor readings and registers the data sources to the digital map of the geographic database 101 by performing a directed search. While traditional localizers or localization techniques are designed to be robust, the localized pose (e.g., the registered data source or feature observation report) can be inaccurate (e.g., laterally off by a lane width or more) in environments with sparse features such as highways, in areas with low location data accuracy, and/or the like, thereby presenting significant technical challenges to ensuring that the collected raw sensor data is as accurate as possible. These challenges are discussed in more detail with respect to FIGS. 2 and 3 below.

FIG. 2 is diagram illustrating an example of localizing crowd-sourced road feature observations, according to one embodiment. In the example of FIG. 2, vehicles 103a-103c (also collectively referred to as vehicles 103) travel on a three-lane highway 201 and detect a map feature 203 (e.g., a road sign) on the left side of the highway 201 and another map feature 205 on the right side of the highway 201. In response to the detection, the vehicles 103 generate respective feature observation reports. In one embodiment, a feature observation report can include but is not limited to data records specifying one or more detected characteristics of the detected feature, respective locations of the detected features, or a combination thereof.

In one embodiment, the feature observation reports and/or corresponding raw sensor data can be collected as part of a feature observation collection process (e.g., crowd-sourced and/or any other type of collection). For example, as shown in FIG. 3, the vehicles 103 that contribute map feature observations 301 and/or raw sensor data to the system 100 have their own respective computer vision systems 107. These computer vision systems 107 can be any type of feature detection system known in the art or equivalent, for instance, comprising individual image recognition software or feature detectors 111 (e.g., machine learning or pattern matching models) and sensors 109 (e.g., optical sensors, radar sensors, LiDAR sensors, location sensors, etc.) that can detect and recognize map features (e.g., road signs, road furniture, intersections, POIs, terrain features, road links, road nodes, etc.), their locations (e.g., detected via location sensors such as Global Positioning System (GPS) sensors or equivalent), and/or any other feature attributes (e.g., feature type, color, shape, etc.) detected by the sensors 109. For example, if the detected feature is a road sign or other road furniture, the map feature observation report 301 can include but is not limited to any of the following data fields: sign value, sign type, latitude, longitude, heading, and/or side of road the sign was detected.

In one embodiment, the map feature observation report 301 can also include location trace data such as location points (e.g., GPS points) and/or location traces (e.g., GPS traces) corresponding to each drive of the vehicles 103. A location or GPS point (e.g., pᵢ) represents location data submitted from a location sensor (e.g., GPS sensor) of the vehicle 103, and can consist of data fields including but not limited to: latitude, longitude, heading, and timestamp. A location trace (e.g., GPS trace) T is a sequence of location points (e.g., T=p₀→p₁→ . . . →pₖ), where the timestamps in the sequence strictly increase. The location trace can also be referred to as a path or trajectory. The location trace data can be reported for all trips or drives performed by the vehicle 103 regardless of whether a map feature observation 301 is made.

In one embodiment, map feature observations 301 can be transmitted from the consumer vehicles 103 to a mapping platform 113 through an Original Equipment Manufacturer (OEM) platform 115 or directly from the consumer vehicles 103 to the mapping platform 113. The OEM platform 115 can be operated by a vehicle manufacturer and can aggregate map feature observations 301, location trace data, and/or related raw sensor data collected from the vehicles 103 that are produced by the manufacturer. The OEM platform 115 can pre-process (e.g., anonymize, normalize, etc.) the map feature observations 301 and/or location trace data before transmitting the processed map feature observations 301 and/or location trace data to the mapping platform 113 (e.g., operated by a map service provider). Although FIG. 2 depicts an example with one OEM platform 115, the mapping platform 113 can have connectivity to multiple OEM platforms 115 (e.g., each corresponding to a different vehicle manufacturer) to collect map feature observations 301, location trace data, raw sensor data, and/or other related data.

Returning to the example of FIG. 2, as each of the vehicles 103a-103c completes a drive passing by the map features 108a and 108b (e.g., road signs), each vehicle 103a-13c can generate map feature observation reports indicating the locations of detected map features 108a and 108b and transmit them to the mapping platform 113. The mapping platform 113 can then localize or register the map feature observations reports to corresponding locations represented in the digital map data of the geographic database 101. As shown, the feature set 203a represents the registered feature observation reports corresponding to map feature 108a as circles corresponding to the registered locations, and the feature set 203b represents the registered feature observation reports corresponding to the map feature 108a. However, as described above, because of potential inaccuracies in the raw sensor data, one or more of the registered feature reports can be localized to inaccurate locations. For example, in the feature set 203a, one registered feature 205 is inaccurately localized to the far left lane of the highway 201 instead of its actual location on the left side of the highway 201. Similarly, in the feature set 203b, one registered feature 207 is inaccurately localized to right of a group of more accurately localized features. If the inaccurate features 205 and 207 are included in the respective feature sets 203a and 203b for calculating detected locations of the map features 108a and 108b, the resulting detected locations would also be less accurate or have higher error.

Traditionally, to avoid or remove such inaccurate or “bad” data from the feature sets 203a and 203b (e.g., leaving only the “good” data), map service providers can be equipped with or use reports only from vehicles with high-accuracy location sensors (e.g., high-accuracy GPS) that can minimize misplaced map features. Other traditional approaches involve manual quality assurance (QA) of the data sources (e.g., map feature observation reports) in which a human operator looks at overlays between the digital map (e.g., HD map) and the crowd-sourced dataset to flag inaccurate observation reports or regions. These traditional approaches, however, are often resource intensive by requiring more expensive and less prevalent high-accuracy sensors, and/or requiring extension manual correction or QA. This resource burden, in turn, can lead to less frequent or less accurate map updates.

To address these challenges, the system 100 introduces a capability to automatically flag or filter inaccurate data from raw sensor data and/or map feature observation reports. In other words, embodiments of the system 100 described herein provide an approach for fully-automated techniques to flag or filter inaccurately localized data sources, such as those involving an off-by-one lane use, thereby advantageously ensuring seamless updates or creation of map features in the digital map data of the geographic database 101. More specifically, the system 100 can ensure reliable data sources (e.g., map feature observation reports) for map updates performed, for instance, in a crowd-sourced manner. In one embodiment, localization techniques are used to register crowd-sourced data to a digital map (e.g., an HD map). Because of crowd-sourcing or the general use of multiple different data sources, the localizer quality can be unknown, especially in the cases of third party algorithms (e.g., localization provided by third parties such as the services platform 119, the services 121a-121n of the services platform 119, and/or content providers 123a-123m), the system 100 can automatically flag inaccuracies to ensure that the quality of the localization results used for map feature updates or creation. The system 100 can then identify the spread of localized-features to perform an inference for mis-localized cases such as data that is off by a lane, other distance threshold, or any other representative metric as relevant for the map-update use-case.

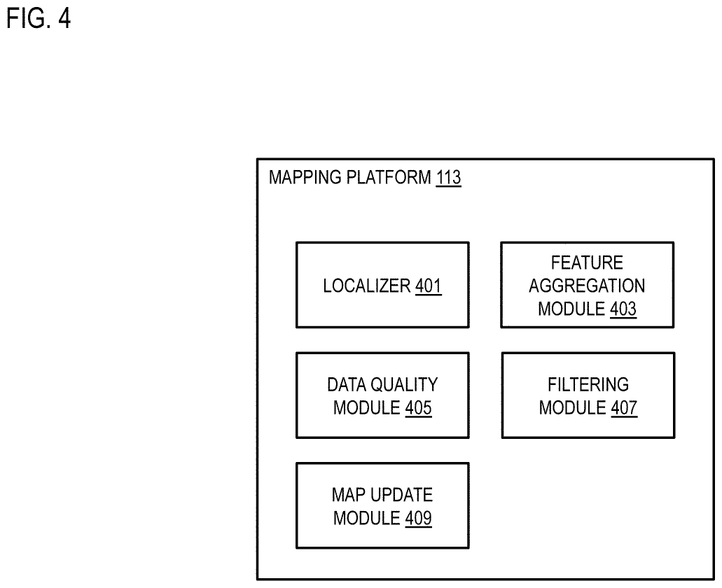

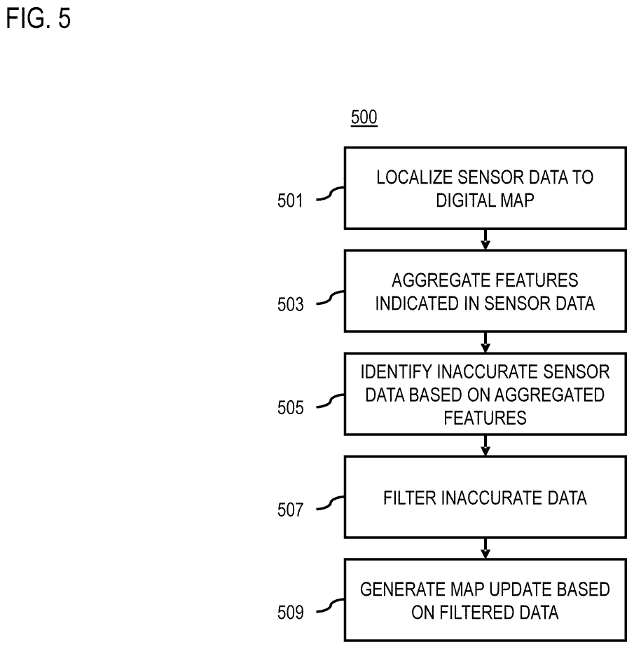

In one embodiment, the mapping platform 113 can perform one or more functions related to providing quality assurance of map feature localization according to the embodiments described herein, and include one or more components as shown in FIG. 4. In this example, the mapping platform 113 includes a localizer 401, feature aggregation module 403, data quality module 405, filtering module 407, and map update module 409. It is contemplated that the functions of these components may be combined in one or more components or performed by other components with similar functionalities (e.g., the OEM platform 115, services platform 119, any of the services 121a-121n (also collectively referred to as services 121, etc.). The above presented modules and components of the mapping platform 113 can be implemented in hardware, firmware, software, or a combination thereof. Though depicted as a separate entity in FIG. 1, it is contemplated that the mapping platform 113 may be implemented as a module of any of the other components of the system 100 (e.g., the computer vision system 107, the vehicle 103, a user equipment (UE) device 125 executing an application 127 to perform the functions, etc.). In another embodiment, one or more of the modules 401-409 may be implemented as a cloud-based service, local service, native application, or combination thereof. The functions of the mapping platform 113 and modules 401-409 are discussed in more detail with respect to FIGS. 5-7 below.

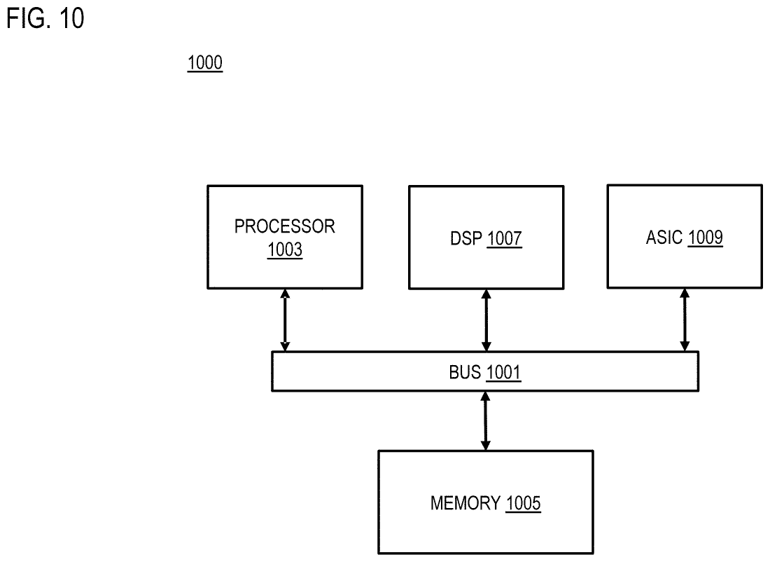

FIG. 5 is a flowchart of a process for providing quality assurance for map feature localization, according to one embodiment. In one embodiment, the mapping platform 113 and/or any of its modules 401-409 may be implemented in, for instance, a chip set including a processor and a memory as shown in FIG. 10 to perform the process 500. As such, the mapping platform 113 and/or the modules 401-409 can provide means for accomplishing various parts of the process 500. In addition or alternatively, the vehicle 103, UE 125, OEM platform 115, services platform 119, and/or one or more of the services 121 may perform any combination of the steps of the process 500 in combination with the mapping platform 113, or as standalone components. Although the process 500 is illustrated and described as a sequence of steps, it is contemplated that various embodiments of the process 500 may be performed in any order or combination and need not include all of the illustrated steps.

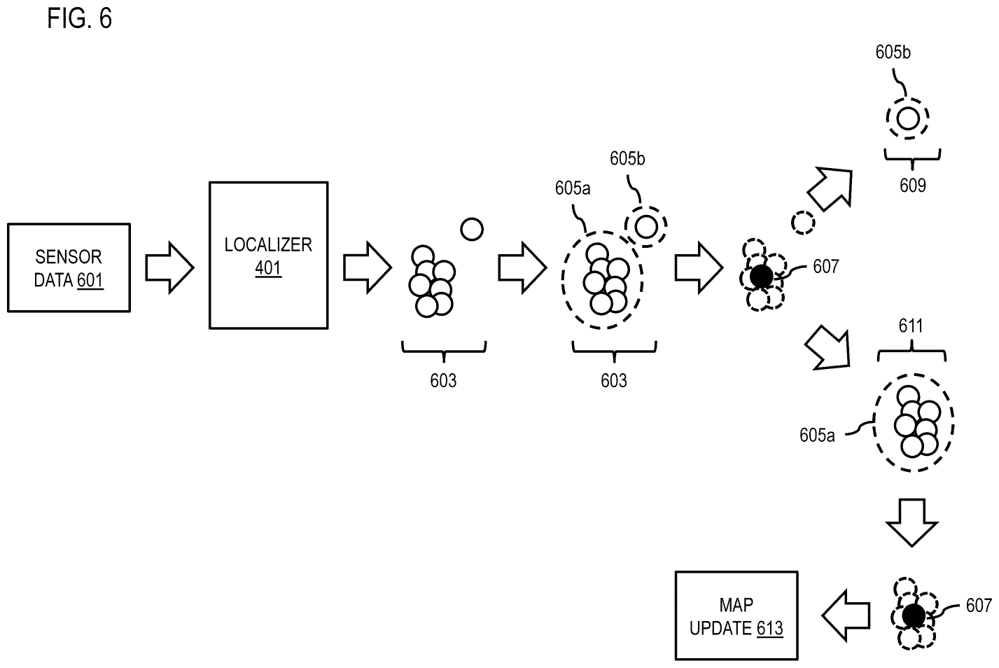

In one embodiment, the process 500 is described in the following stages—an overview of localizer (e.g., step 501), feature aggregation (e.g., step 503), identification of inaccurate data (e.g., step 505), and optional uses cases (e.g., step 507 for filtering inaccurate data, and/or step 509 for generating map updates based on filtered data). In addition, the description of the process 500 below also refers to the example diagram of FIG. 6.

In step 501, the localizer 401 is used to register data sources (e.g., collected raw sensor data 601 as shown in FIG. 6 and/or map feature observation reports) to the digital map (e.g., an HD map of the geographic database 101). In one embodiment, for localization, raw sensor data 601 (e.g., in the form of GPS location point or trace data, odometry data, etc.) is used as an initial estimate for starting a directed search of the geographic database 101 that registers the sensor readings 601 to the digital map. In other words, the localizer 401 translates the sensed geographic coordinates for the detected features indicated in the sensor data 601 and/or map feature observation reports to specific locations represented in the digital map data. As discussed above, the detected feature can be any mappable feature of a geographic area including, but not limited to, road signs, road furniture, lane markings, nodes, links, etc. and/or any characteristics/attributes thereof.

By way of example, the localizer 401 can use any localization algorithm or process to register the sensor data 601 or reported feature observations to the digital map to determine location data (e.g., geographic coordinates, associated road links/nodes, etc.) for the detected features. The localization algorithm, for instance, searches over several estimated vehicle poses (e.g., position and direction of the vehicle that collected/reported the raw sensor data/observation report of the detected feature). The localization algorithm then determines the best pose such that the measurements obtained from the reporting vehicle's sensor (e.g., measurements of the location/position of the detected feature) most agrees with the digital map. For example, determining agreement with the map can include but is not limited to determining that the vehicle pose corresponds to the direction or heading of a road link or segment of the digital map. In one embodiment, the localization or registering of the sensor data 601 to the digital comprises lane-level localization of the detected features. Lane-level localization refers to registering the sensor data 601 to individual lanes of multi-lane road links (e.g., a specific lane of a multi-lane highway), or to an accuracy equivalent to or capable of distinguishing a typical road lane width (e.g., 9-12 feet).

In one embodiment, each raw sensor data point or observation can correspond to a crowd-sourced drive performed by one or more vehicles 103. In this case, the localizer 401 can be run for each drive to register the reported feature detection data to the map, leading to an aggregation of features (step 503). For example, the feature aggregation module 403 can process the sensor data 601 collected from a plurality of vehicles 103 to aggregate the features indicated in the sensor data 601 into a feature set 603. It is contemplated that the aggregation can use any attribute or characteristic of the detected features into the feature set including but not limited to location (e.g., detected features within a predetermined distance threshold are grouped into the feature set), feature type (e.g., detected features of a type of interest (e.g., a road sign) can be grouped together), feature attribute (e.g., signs with a triangular shape as an attribute and/or a specified color can be grouped together), and/or any combination thereof.

The feature aggregation module 403 can then cluster the registered features of each drive or reported instance of the aggregated feature set 603. For example, within each feature set 603, the feature observation reports that are close in space (e.g., within clustering criteria) can be clustered using any clustering technique known in the art (e.g., k-means clustering, DBSCAN clustering, etc.) to determine one or more feature clusters (e.g., clusters 605a and 605b of the feature set 603). To perform the clustering, the feature aggregation module 403 can designate default clustering parameters criteria. The clustering parameters can include but are not limited to: a minimum number of feature observations per cluster, distance threshold for a feature observation to be included in a cluster, and/or the like. Additionally, the clustering parameters can be learned directly from data to maximize a pre-determined metric. For example, the feature aggregation module 403 can require at least three TSR observations that are within a distance threshold (e.g., 15 m) and/or any other specified or learned clustering parameter to create a clusters 605a and 605b.

In one embodiment, the feature aggregation module can also enforce a minimum number of drives or observations to be collected before completing the aggregation process and proceeding onto subsequent steps by, for instance, determining whether that a count of the individual drives represented in the sensor data is greater than a threshold value. The feature aggregation module 403 can then determine a consensus pattern 607 based on or otherwise indicated by the feature clusters 605a and 605b. For example, feature clusters 605a and 605b in the aggregate data can show the consensus pattern 607 representing an estimate of the true location of a detected feature corresponding to the feature set 603. In one embodiment, the consensus pattern 607 (e.g., an estimated or predicted true location of the feature) can be determined based on an overlap of the detected feature locations of feature clusters 605a and 605b (e.g., overlap within a threshold distance of each other such as the threshold corresponding to the diameter of the illustrated circle representing each detected feature). The location where the features most overlap (e.g., a centroid of the overlapping features or feature clusters) can then be used as the consensus pattern 607 or estimated true location of the detected feature represented in the feature set 603.

In the case where the localizer 401 has failed to achieve a target level of accuracy (e.g., achieve lane-level accuracy), the feature set 603 obtained will also exhibit a corresponding level of inaccuracy (e.g., register feature detections that are off by a lane in the highway or equivalent distance). Accordingly, in step 505, the data quality module 405 can identify inaccurate feature detection data by comparing the detected feature locations of the feature clusters 605a and 605b against the consensus pattern 607 for the feature set 603. In other words, the clustering algorithm of step 503 is run for each feature set 603, and those clusters 605a/605b or features in the feature set 603 that are in disagreement with the consensus pattern 607 can be flagged or otherwise identified as inaccurate data 609. The data quality module 405, for instance, can determine at least one feature cluster (e.g., feature cluster 605b) or feature in the feature set 603 being analyzed that does not match the consensus pattern 607, and then automatically designate the sensor data 601 or feature observation report corresponding to the non-matching feature cluster 605b as inaccurate sensor data 609. Conversely, sensor data 601 (e.g., data in feature cluster 605a) that matches or agrees with the consensus pattern 607 can be flagged or otherwise identified as accurate data 611.

In one embodiment, the mapping platform 113 can then use the processed sensor data 601 for any number of use cases. For example, in step 507, the filtering module 107 can filter the inaccurate sensor data 609 from the set of sensor data 601 that is to be used by other components of the mapping platform 113 or system 100 for providing services, functions, applications, etc. One example function includes but is not limited to generating more accurate map updates. In one embodiment, the map update module 409 uses the filtered data (e.g., the accurate data 611 which as the inaccurate data 609 removed) for the feature set 603 corresponding to a detected feature to determine the true location (e.g., the consensus pattern 607) of the detected feature. In this way, accurate data 611 (e.g., the filtered data) that agrees with the cluster consensus pattern 607 can then be used to generate the map update 613. For example, the true location or consensus pattern 607 can then be used to update the digital map data of the geographic database 101 with an accurate location of the detected feature.

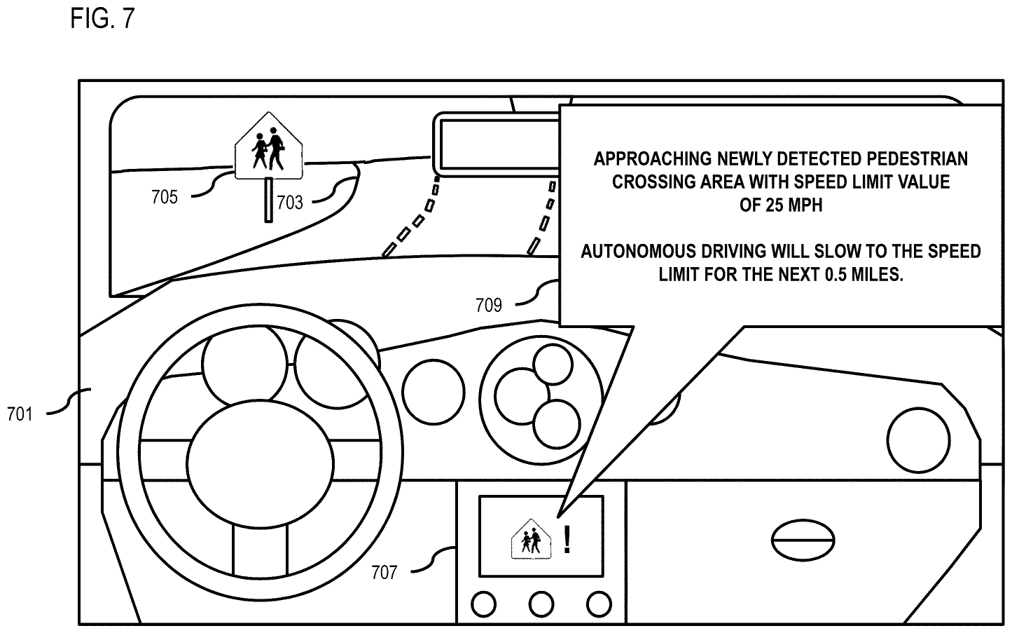

FIG. 7 is a diagram illustrating an example of using learned traffic sign data for autonomous driving, according to one embodiment. In the example of FIG. 7, a vehicle 701 is driving autonomously and approaches a road segment 703 with a newly posted traffic sign 705 indicating a pedestrian crossing area. On or before approaching the road segment 1403, the vehicle 701 queries the geographic database 101 for a map update for the geographic area including the road segment 703. The geographic database 101 returns digital map data indicating the newly detected feature (e.g., the road sign 705) (e.g., over the communication network 105). The map update, in this case, was generated from crowd-sourced feature map observations that has been collected and automatically processed to remove inaccurate crowd-sourced data according to the embodiments described herein.

For example, given a collected set of map feature observations from multiple vehicles 103 (or multiple OEM platforms 115) and/or vehicle drives in a sensor chain (e.g., stored in sensor database 117), the mapping platform 113 can cluster the feature observations or corresponding raw sensor data according to location and/or one or more detected sign properties (e.g., a sign value, sign type, etc.) to detect the newly placed sign and create a map update. In this example, the feature observations or raw sensor are processed to filter inaccurate data according to the embodiments described herein. By way of example, a newly placed sign is determined based on current clusters and a comparison to an earlier map such as a map of signs from the day before. For example, if the comparison indicates that a detected sign was not present in the earlier map, the system 100 can designate that learned sign as a newly placed sign. The system 100 then identifies the road link to which the learned sign or sign property or value applies using the filtered or accurate sensor data (e.g., via map matching), and updates the road link record of the geographic database 101 corresponding to the identified road link accordingly.

As a result, the vehicle 701 has accurate data indicating the position of the newly detected traffic sign 705 appearing on the left side of the road 703. In response, the vehicle 701 can automatically slow down to a default speed limit of 25 mph to improve pedestrian safety. While no message need be shown to the driver or passengers of the vehicle 701, in this example (for illustration purposes), a navigation system 707 of the vehicle 701 can present an alert 709 that the vehicle 1401 is approaching a newly detected pedestrian crossing area with a speed limit of 25 mph, and that the vehicle 701 will be slowing down accordingly for the length of the corresponding road segment 703 (e.g., 0.5 miles).

Returning to FIG. 1, as shown, the system 100 includes a consumer or OEM vehicle 103 with connectivity to the mapping platform 113 and/or OEM platform 115 for providing map feature observations or raw sensor data that are automatically processed for quality assurance according to the various embodiments described herein. In one embodiment, the vehicle 103 includes the computer vision system 107 with sensors 109 and an in-vehicle feature detector 111 for generating map feature observations. In some use cases, with respect to autonomous, navigation, mapping, and/or other similar applications, the in-vehicle feature detector 111 can detect map features (e.g., traffic signs) and their properties from input sensor data and generate map feature observations reports.

In one embodiment, the mapping platform 113 can also include a supervised learning mechanism or equivalent that can include one or more feature detection models such as, but not limited to, neural networks, SVMs, decision trees, etc. to detect and process map features for quality assurance. For example, the supervised learning mechanism can be based on a neural network such as a traditional convolutional neural network which consists of multiple layers of collections of one or more neurons (e.g., processing nodes of the neural network) which are configured to process input feature sets.

In one embodiment, the mapping platform 113, vehicle 103, UE 125, and/or other end user devices also have connectivity or access to the geographic database 101 which stores representations of mapped geographic features to facilitate autonomous driving and/or other mapping/navigation-related applications or services. The geographic database 101 can also store map features learned and processed for quality assurance according to the various embodiments described herein.

In one embodiment, the mapping platform 113, OEM platform 115, vehicle 103, UE 125, etc. have connectivity over the communication network 105 to the services platform 119 that provides one or more services 121 related to traffic sign learning (e.g., third-party traffic sign data services). By way of example, the services 121 may be third party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the mapping platform 113, OEM platform 115, services platform 119, and/or other components of the system 100 may be platforms with multiple interconnected components. The mapping platform 113, OEM platform 115, services platform 119, etc. may include multiple servers, intelligent networking devices, computing devices, components and corresponding software for providing quality assurance of detected map features. In addition, it is noted that the mapping platform 113, OEM platform 115, computer vision system 107, etc. may be separate entities of the system 100, a part of the one or more services 121, a part of the services platform 119, or included within the UE 125 and/or vehicle 103.

In one embodiment, content providers 123a-123m (collectively referred to as content providers 123) may provide content or data (e.g., including learned traffic sign data or other geographic data) to the geographic database 101, the mapping platform 113, the computer vision system 107, the services platform 119, the services 121, the UE 125, the vehicle 103, and/or an application 127 executing on the UE 125. The content provided may be any type of content, such as map content, textual content, audio content, video content, image content, etc. In one embodiment, the content providers 123 may provide content that may aid in the detecting and ensuring the quality of map features and their properties from sensor data, and estimating the confidence and/or accuracy of the detected features. In one embodiment, the content providers 123 may also store content associated with the geographic database 101, mapping platform 113, OEM platform 115, computer vision system 107, services platform 119, services 121, UE 125, and/or vehicle 103. In another embodiment, the content providers 123 may manage access to a central repository of data, and offer a consistent, standard interface to data, such as a repository of the geographic database 101.

In one embodiment, the UE 125 and/or vehicle 103 may execute a software application 127 to collect, encode, and/or decode map feature observations for automated quality assurance according the embodiments described herein. By way of example, the application 127 may also be any type of application that is executable on the UE 125 and/or vehicle 103, such as autonomous driving applications, mapping applications, location-based service applications, navigation applications, content provisioning services, camera/imaging application, media player applications, social networking applications, calendar applications, and the like. In one embodiment, the application 127 may act as a client for the mapping platform 113, OEM platform 115, services platform 119, and/or services 121 and perform one or more functions associated with traffic sign learning.

By way of example, the UE 125 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 125 can support any type of interface to the user (such as “wearable” circuitry, etc.). In one embodiment, the UE 125 may be associated with the vehicle 103 or be a component part of the vehicle 103.

In one embodiment, the UE 125 and/or vehicle 103 are configured with various sensors for generating or collecting environmental sensor data (e.g., for processing by the in-vehicle feature detector 111 and/or mapping platform 113), related geographic data, etc. including but not limited to, optical, radar, ultrasonic, LiDAR, etc. sensors. In one embodiment, the sensed data represent sensor data associated with a geographic location or coordinates at which the sensor data was collected. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the UE 125 and/or vehicle 103 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE 125 and/or vehicle 103 may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE 125 and/or vehicle 103 may include GPS or other satellite-based receivers to obtain geographic coordinates from satellites for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 113, OEM platform, services platform 119, services 121, UE 125, vehicle 103, and/or content providers 123 communicate with each other and other components of the system 100 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

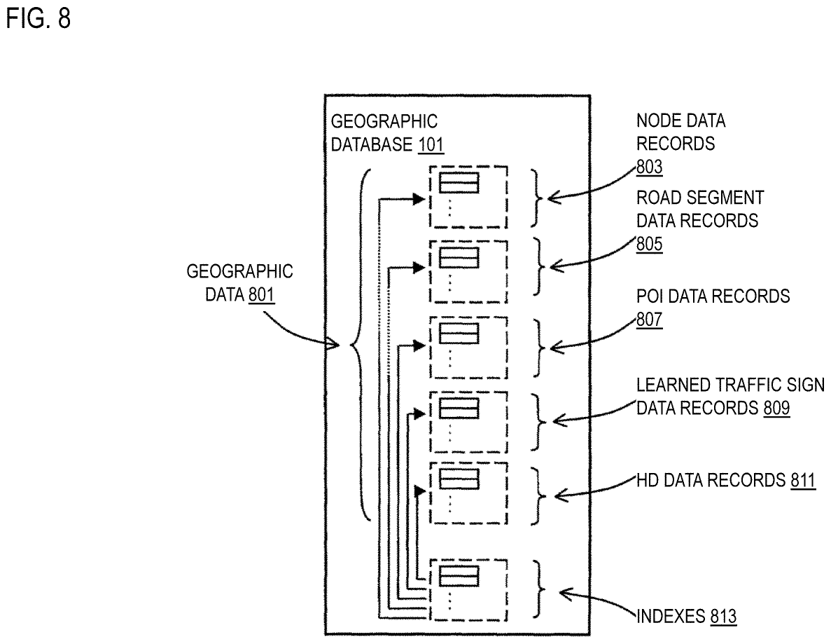

FIG. 8 is a diagram of a geographic database 101, according to one embodiment. In one embodiment, the geographic database 101 includes geographic data 801 used for (or configured to be compiled to be used for) mapping and/or navigation-related services. In one embodiment, the geographic database 101 includes high resolution or high definition (HD) mapping data that provide centimeter-level or better accuracy of map features. For example, the geographic database 101 can be based on Light Detection and Ranging (LiDAR) or equivalent technology to collect billions of 3D points and model road surfaces and other map features down to the number lanes and their widths. In one embodiment, the HD mapping data (e.g., HD data records 811) capture and store details such as the slope and curvature of the road, lane markings, roadside objects such as sign posts, including what the signage denotes. By way of example, the HD mapping data enable highly automated vehicles to precisely localize themselves on the road, and to determine road attributes (e.g., learned speed limit values) to at high accuracy levels.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 101.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 101 follows certain conventions. For example, links do not cross themselves and do not cross each other except at a node. Also, there are no duplicated shape points, nodes, or links. Two links that connect each other have a common node. In the geographic database 101, overlapping geographic features are represented by overlapping polygons. When polygons overlap, the boundary of one polygon crosses the boundary of the other polygon. In the geographic database 101, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 101 is stored as a hierarchical or multilevel tile-based projection or structure. More specifically, in one embodiment, the geographic database 101 may be defined according to a normalized Mercator projection. Other projections may be used. By way of example, the map tile grid of a Mercator or similar projection is a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom or resolution level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid 10. In one embodiment, the quadkey is an example of the hash or encoding scheme of the respective geographical coordinates of a geographical data point that can be used to identify a tile in which the geographical data point is located.

As shown, the geographic database 101 includes node data records 803, road segment or link data records 805, POI data records 807, detected map feature data records 809, HD mapping data records 811, and indexes 813, for example. More, fewer or different data records can be provided. In one embodiment, additional data records (not shown) can include cartographic (“carto”) data records, routing data, and maneuver data. In one embodiment, the indexes 813 may improve the speed of data retrieval operations in the geographic database 101. In one embodiment, the indexes 813 may be used to quickly locate data without having to search every row in the geographic database 101 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points corresponding to the respective links or segments of the road segment data records 805. The road link data records 805 and the node data records 803 represent a road network, such as used by vehicles, cars, and/or other entities. Alternatively, the geographic database 101 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 101 can include data about the POIs and their respective locations in the POI data records 807. The geographic database 101 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city).

In one embodiment, the geographic database 101 can also include detected map feature data records 809 for storing map features observations (e.g., including aggregates, clusters, and data quality classifications) as well as data on their respective properties. The map feature data records 809 can also store confidence or accuracy determinations for the sensor data or observation reports used to detect the map features. By way of example, the map feature data records 809 can be associated with one or more of the node records 803, road segment records 805, and/or POI data records 807 to support uses cases such as enhanced mapping UIs, autonomous driving, dynamic map updates, etc. In one embodiment, the map feature data records 809 are stored as a data layer of the hierarchical tile-based structure of the geographic database 101 according to the various embodiments described herein. In one embodiment, the geographic database 101 can provide tile-based feature detection data records 809 to generate map updates according to embodiments described herein.

In one embodiment, as discussed above, the HD mapping data records 811 model road surfaces and other map features to centimeter-level or better accuracy. The HD mapping data records 811 also include lane models that provide the precise lane geometry with lane boundaries, as well as rich attributes of the lane models. The lane geometry can be used to localize sensor data or feature observations at lane-level accuracy or above. The HD mapping data records 811 can also include rich attributes such as, but not limited to, lane traversal information, lane types, lane marking types, lane level speed limit information, and/or the like. In one embodiment, the HD mapping data records 811 are divided into spatial partitions of varying sizes to provide HD mapping data to vehicles 103 and other end user devices with near real-time data (e.g., map feature data) without overloading the available resources of the vehicles 103 and/or devices (e.g., computational, memory, bandwidth, etc. resources).

In one embodiment, the HD mapping data records 811 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 811.

In one embodiment, the HD mapping data records 811 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time sensor data also at centimeter-level accuracy. Other sensor data can include vehicle telemetry or operational data such as windshield wiper activation state, braking state, steering angle, accelerator position, and/or the like.

In one embodiment, the geographic database 101 can be maintained by the content provider 123 in association with the services platform 119 (e.g., a map developer). The map developer can collect geographic data to generate and enhance the geographic database 101. There can be different ways used by the map developer to collect data. These ways can include obtaining data from other sources, such as municipalities or respective geographic authorities. In addition, the map developer can employ field personnel to travel by vehicle (e.g., vehicle 103 and/or UE 125) along roads throughout the geographic region to observe features and/or record information about them, for example. Also, remote sensing, such as aerial or satellite photography, can be used.

The geographic database 101 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by a vehicle 103 or UE 125. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing quality assurance for map feature localization may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

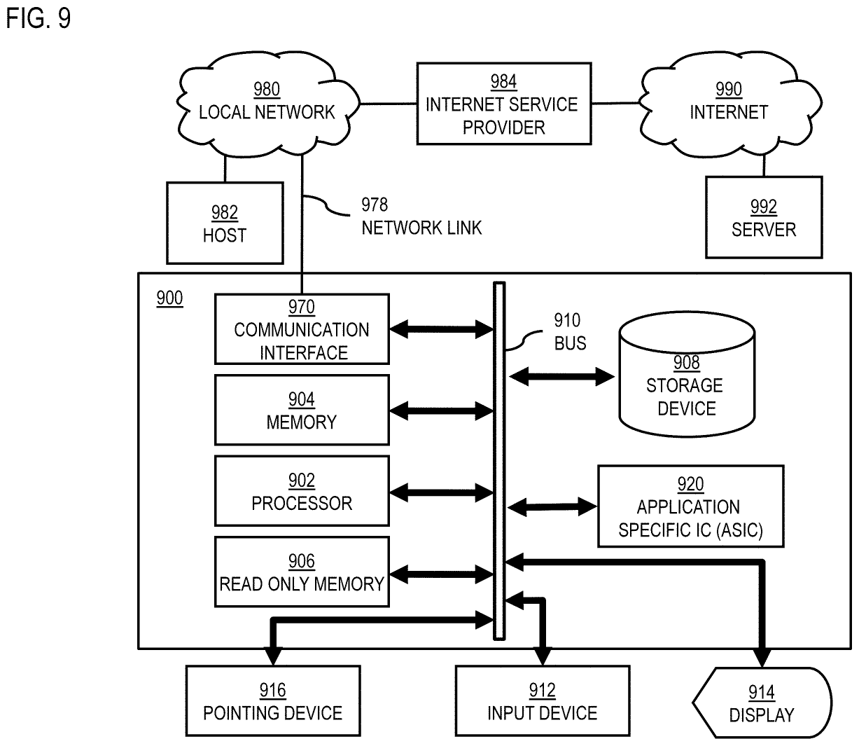

FIG. 9 illustrates a computer system 900 upon which an embodiment of the invention may be implemented. Computer system 900 is programmed (e.g., via computer program code or instructions) to providing quality assurance for map feature localization as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to providing quality assurance for map feature localization. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for providing quality assurance for map feature localization. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing quality assurance for map feature localization, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing quality assurance for map feature localization.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to provide quality assurance for map feature localization as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide quality assurance for map feature localization. The memory 1005 also stores the data associated with or generated by the execution of the inventive steps.

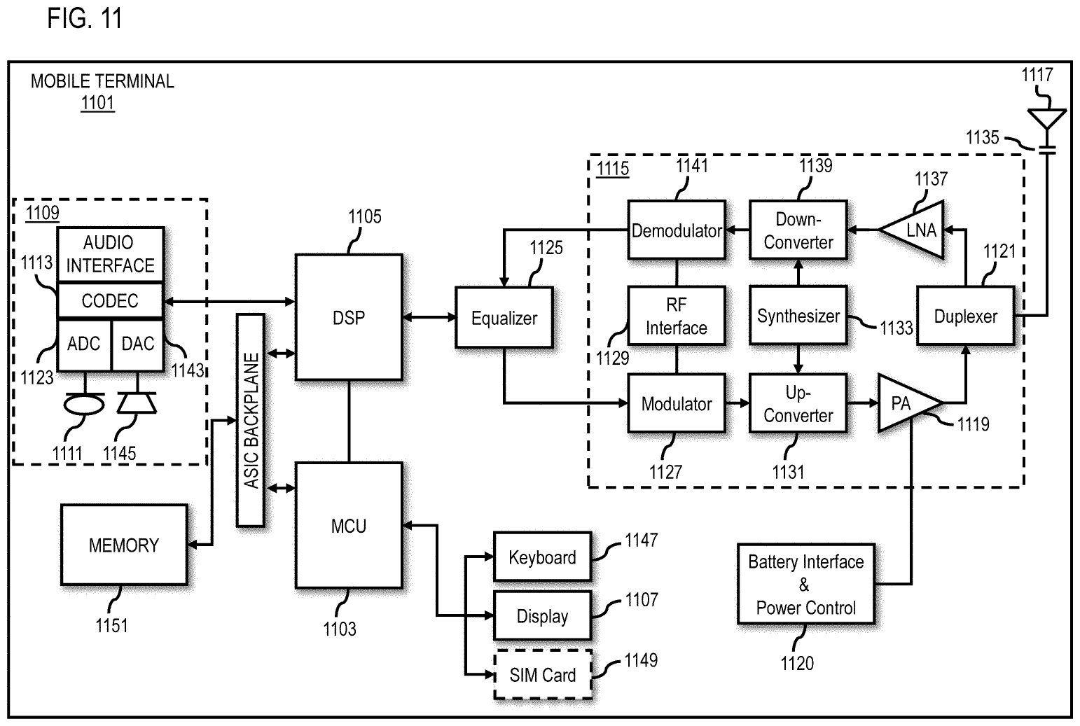

FIG. 11 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to provide quality assurance for map feature localization. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
processing sensor data collected from a plurality of vehicles to aggregate a plurality of features indicated in the sensor data into a feature set;
clustering the feature set into a plurality of feature clusters;
determining a consensus pattern based on the plurality of feature clusters;
determining at least one feature cluster of the plurality of feature clusters that does not match the consensus pattern; and
automatically designating the sensor data corresponding to the at least one feature cluster as inaccurate sensor data.

2. The method of claim 1, further comprising:
filtering the inaccurate sensor data from the sensor data; and
processing the filtered sensor data to generate a map update.

3. The method of claim 1, wherein the consensus pattern is determined based on an overlap of the plurality of features.

4. The method of claim 1, further comprising:
registering the sensor data to a digital map to determine location data for the plurality of features,
wherein the clustering of the feature set is based on the location data.

5. The method of claim 4, wherein the registering of the sensor data to the digital map comprises lane-level localization of the plurality of features.

6. The method of claim 2, further comprising:
processing the location data of the filtered sensor data corresponding to the consensus pattern to determine a consensus location for a map feature corresponding to the plurality of features.

7. The method of claim 1, wherein the sensor data is collected with respect to individual drives of the plurality of vehicles.

8. The method of claim 7, wherein the aggregating of the plurality of features, the clustering of the feature set, the determining of the consensus pattern, the determining of the at least one feature cluster, the designating of the sensor data corresponding to the at least one feature cluster, or a combination thereof is based on determining that a count of the individual drives represented in the sensor data is greater than a threshold value.

9. The method of claim 1, wherein the sensor data is crowd-sourced from the plurality of vehicles.

10. The method of claim 1, wherein the sensor data includes satellite-based location data, odometry-based location data, or a combination thereof.

11. An apparatus comprising:
at least one processor; and
at least one memory including computer program code for one or more programs,
the at least one memory and the computer program code configured to, with the at least one processor, cause the apparatus to perform at least the following,
process sensor data collected from a plurality of vehicles to aggregate a plurality of features indicated in the sensor data into a feature set;
cluster the feature set into a plurality of feature clusters;
determine a consensus pattern based on the plurality of feature clusters;
determine at least one feature cluster of the plurality of feature clusters that does not match the consensus pattern; and
automatically designate the sensor data corresponding to the at least one feature cluster as inaccurate sensor data.

12. The apparatus of claim 11, wherein the apparatus is further caused to:
filter the inaccurate sensor data from the sensor data; and
process the filtered sensor data to generate a map update.

13. The apparatus of claim 11, wherein the apparatus is further caused to:
register the sensor data to a digital map to determine location data for the plurality of features,
wherein the clustering of the feature set is based on the location data.

14. The apparatus of claim 13, wherein the apparatus is further caused to:
process the location data of the filtered sensor data corresponding to the consensus pattern to determine a consensus location for a map feature corresponding to the plurality of features.

15. The apparatus of claim 11, wherein the aggregating of the plurality of features, the clustering of the feature set, the determining of the consensus pattern, the determining of the at least one feature cluster, the designating of the sensor data corresponding to the at least one feature cluster, or a combination thereof is based on determining that a count of individual drives represented in the sensor data is greater than a threshold value.

16. A non-transitory computer-readable storage medium carrying one or more sequences of one or more instructions which, when executed by one or more processors, cause an apparatus to perform:
processing sensor data collected from a plurality of vehicles to aggregate a plurality of features indicated in the sensor data into a feature set;
clustering the feature set into a plurality of feature clusters;
determining a consensus pattern based on the plurality of feature clusters;
determining at least one feature cluster of the plurality of feature clusters that does not match the consensus pattern; and
automatically designating the sensor data corresponding to the at least one feature cluster as inaccurate sensor data.

17. The non-transitory computer-readable storage medium of claim 16, wherein the apparatus is further caused to perform:
filtering the inaccurate sensor data from the sensor data; and
processing the filtered sensor data to generate a map update.

18. The non-transitory computer-readable storage medium of claim 16, wherein the apparatus is further caused to perform:
registering the sensor data to a digital map to determine location data for the plurality of features,
wherein the clustering of the feature set is based on the location data.

19. The non-transitory computer-readable storage medium of claim 18, wherein the apparatus is further caused to perform:
processing the location data of the filtered sensor data corresponding to the consensus pattern to determine a consensus location for a map feature corresponding to the plurality of features.

20. The non-transitory computer-readable storage medium of claim 16, wherein the aggregating of the plurality of features, the clustering of the feature set, the determining of the consensus pattern, the determining of the at least one feature cluster, the designating of the sensor data corresponding to the at least one feature cluster, or a combination thereof is based on determining that a count of individual drives represented in the sensor data is greater than a threshold value.
